(19) United States
(12) Patent Application Publication
(10) Pub. No.: US 2023/0243548 A1
(43) Pub. Date: Aug. 3, 2023

(54) MULTI-FUNCTION RECOVERY VENTILATOR

(71) Applicant: Carrier Corporation, Palm Beach Gardens, FL (US)

(72) Inventor: Peter McKinney, Boulder, CO (US)

(21) Appl. No.: 18/159,608

(22) Filed: Jan. 25, 2023

Related U.S. Application Data
(60) Provisional application No. 63/267,265, filed on Jan. 28, 2022.

(51) Int. Cl. F24F 12/00; F24F 11/81; F24F 13/10

(52) U.S. Cl. CPC F24F 12/006; F24F 11/81; F24F 13/10; F24F 2110/10

(57) ABSTRACT

A ventilator comprising a housing, a first flowpath extending from a first inlet to a first outlet and a second flowpath extending from a second inlet to a second outlet, wherein the housing comprises a partition defining a first chamber and a second chamber therein, and wherein the first flowpath extends through both the first and second chamber and the second flowpath extends through at least one of the first chamber or second chamber; a first movable damper disposed in the first flowpath and configured to apportion an amount of a first fluid flowing therein between the first chamber and the second chamber; and a first recovery core comprising a plurality of first passageways and a plurality of second passageways disposed in the first chamber such that the plurality of first passageways fluidly communication with the first flowpath and the plurality of second passageways fluidly communication with the second flowpath.

### CROSS REFERENCE TO A RELATED APPLICATION

The application claims the benefit of U.S. Provisional Application No. 63/267,265 filed Jan. 28, 2022, the contents of which are hereby incorporated in their entirety.

### BACKGROUND

Exemplary embodiments pertain to the art of recovery ventilators. More particularly, the present disclosure relates to configurations of heat recovery ventilators, energy recovery ventilator, and combinations thereof.

Flat plate air-to-air heat exchangers can be used to recover thermal energy and/or moisture from building ventilation air that has been conditioned prior to exhausting the conditioned air outside the building. They can operate on the outside air as “preconditioners” upstream of heating and/or cooling coils that are used for thermal conditioning of the building supply air. These devices offer energy efficiency improvements to building environmental conditioning systems by recapturing heating, cooling, humidification, or dehumidification effects that that would otherwise go wasted as the building air is exhausted. As building energy demand for environmental conditioning continues to form a major portion of global energy demand, there remains a need for energy efficient configurations and operating approaches to maximize the effectiveness of recovery devices and deliver corresponding energy savings.

### BRIEF DESCRIPTION

Disclosed is a recovery ventilator comprising a housing comprising a first flowpath extending from a first inlet to a first outlet and a second flowpath extending from a second inlet to a second outlet, wherein the housing comprises a partition defining a first chamber and a second chamber therein, and wherein the first flowpath extends through both the first and second chamber and the second flowpath extends through at least one of the first chamber or second chamber; a first movable damper disposed in the first flowpath and configured to apportion an amount of a first fluid flowing therein between the first chamber and the second chamber; and a first recovery core comprising a plurality of first passageways and a plurality of second passageways disposed in the first chamber such that the plurality of first passageways are in fluid communication with the first flowpath and the plurality of second passageways are in fluid communication with the second flowpath.

In accordance with additional or alternative embodiments, wherein the first movable damper is positioned such that the first flowpath and the second flowpath cross in at least one of the first chamber or second chamber.

In accordance with additional or alternative embodiments, wherein the first movable damper is positioned such that the first flowpath and the second flowpath do not cross in the first chamber or second chamber.

In accordance with additional or alternative embodiments, further comprising a second recovery core comprising a plurality of first passageways and a plurality of second passageways, wherein the second recovery core is disposed in the second chamber such that the plurality of first passageways are in fluid communication with the first flowpath and the plurality of second passageways are in fluid communication with the second flowpath, and wherein the first flowpath the second flowpath cross in both the first chamber and second chamber.

In accordance with additional or alternative embodiments, wherein the first movable damper is configured to direct a substantial portion of the first fluid flowing therein along the first flowpath through the first chamber when in a first position and through the second chamber when in a second position.

In accordance with additional or alternative embodiments, further comprising a second movable damper disposed in the second flowpath and configured to apportion an amount of a second fluid flowing therein between the first chamber and the second chamber.

In accordance with additional or alternative embodiments, wherein the second movable damper is configured to direct a substantial portion of the second fluid flowing along the second flowpath through the first chamber when in a first position and to through the second chamber when in a second position.

In accordance with additional or alternative embodiments, wherein the plurality of first passageways and the plurality of second passageways of the first recovery core are separated by a first barrier configured to transfer at least one of water or thermal energy across the barrier.

In accordance with additional or alternative embodiments, wherein the plurality of first passageways and the plurality of second passageways of the second recovery core are separated by a second barrier configured to transfer at least one of water or thermal energy across the barrier.

In accordance with additional or alternative embodiments, wherein the first barrier of the first recovery core is configured to transfer water and thermal energy, and the second barrier of the second recovery core is configured to transfer thermal energy.

In accordance with additional or alternative embodiments, wherein the first flowpath and the second flowpath each pass through one another where they cross.

In accordance with additional or alternative embodiments, wherein at least one of the first barrier or the second barrier comprises a polymer membrane.

In accordance with additional or alternative embodiments, further comprising a third core comprising one or more first passageways and one or more second passageways; and one or more actuators, coupled to the first recovery core, the second recovery core, and the third core and configured to shift the physical location of the first recovery core, second recovery core, and third recover cores between: a first condition wherein the plurality of first passageways of the first recovery core are disposed in fluid communication with the first fluid flowing along the first flowpath and the plurality of second passageways of the first recovery core are disposed in fluid communication with the second fluid flowing along the second flowpath, wherein the second recovery core and the third core are disposed outside of the first and second flowpaths; a second condition wherein the plurality of first passageway of the second recovery core are disposed in fluid communication with the first fluid flowing along the first flowpath and the plurality of second passageways of the second recovery core are disposed in fluid communication with the second fluid flowing along the second flowpath, wherein the first recovery core and the third core are disposed outside of the first and second flowpaths; and a third condition wherein the one or more first passageway of the third core are disposed in fluid communication with the first fluid flowing along the first flowpath and the one or more second passageways of the third core are disposed in fluid communication with the second fluid flowing along the second flowpath, wherein the first recovery core and the second recovery core are disposed outside of the first and second flowpaths.

Further disclosed is a space ventilating system comprising the ventilator as in any one of the preceding claims; an environmental sensor comprising at least one of a first inlet temperature sensor at the first inlet, a first inlet humidity sensor at the first inlet, a first outlet temperature sensor at the first outlet, a first outlet humidity sensor at the first outlet, a second inlet temperature sensor at the second inlet, a second inlet humidity sensor at the second inlet, a second outlet temperature sensor at the second outlet or a second outlet humidity sensor at the second outlet; a controller configured to receive a signal from the environmental sensor and to move the first movable damper between first position wherein the first movable damper is configured to direct a substantial portion of the first fluid flowing therein along the first flowpath through the first chamber, and a second position wherein the first movable damper is configured to direct a substantial portion of the first fluid flowing therein along the first flowpath through the second chamber, when the signal satisfies a threshold condition.

In accordance with additional or alternative embodiments, wherein the threshold condition comprises a threshold temperature, threshold humidity, or a combination thereof.

Further disclosed is a method of ventilating a space comprising providing a recovery ventilator comprising a housing having a partition defining a first chamber and a second chamber therein, a first flowpath extending from a first inlet to a first outlet, a second flowpath extending from a second inlet to a second outlet, wherein the first flowpath and the second flowpath cross in at least one of the first chamber and second chamber; a first movable damper disposed in the first flowpath and configured to apportion an amount of a first fluid flowing therein between the first chamber and the second chamber; and a first recovery core comprising a plurality of first passageways and a plurality of second passageways disposed in the first chamber such that the plurality of first passageways are in fluid communication with the first flowpath and the plurality of second passageways are in fluid communication with the second flowpath; receiving a target environmental condition for the space; flowing the first fluid along the first flowpath; measuring a property of the first fluid at one or more points along the first flowpath; and moving the first movable damper from a first position, substantially obstructing the second chamber from the first flowpath, to a second position, substantially obstructing the first chamber from the first flowpath, such that a substantial portion of the first fluid is directed through the second chamber when the property satisfies a threshold condition.

In accordance with additional or alternative embodiments, moving the first movable damper from the second position, substantially obstructing the first chamber from the first flowpath, to the first position, substantially obstructing the second chamber from the first flowpath, such that a substantial portion of the first fluid is directed through the first chamber when the property fails to satisfy the threshold condition.

Further disclosed is a method of ventilating a space comprising: providing a recovery ventilator comprising a housing having a partition defining a first chamber and a second chamber therein, a first flowpath extending from a first inlet to a first outlet, a second flowpath extending from a second inlet to a second outlet, wherein the first flowpath and the second flowpath cross in at least one of the first chamber and second chamber; a first movable damper disposed in the first flowpath and configured to apportion an amount of a first fluid flowing therein between the first chamber and the second chamber; a first recovery core comprising a plurality of first passageways and a plurality of second passageways disposed in the first chamber such that the plurality of first passageways are in fluid communication with the first flowpath and the plurality of second passageways are in fluid communication with the second flowpath; a second recovery core comprising a plurality of first passageways and a plurality of second passageways disposed in the second chamber such that the plurality of first passageways are in fluid communication with the first flowpath and the plurality of second passageways are in fluid communication with the second flowpath, and a second movable damper disposed in the second flowpath and configured to apportion an amount of a second fluid flowing therein between the first chamber and the second chamber; and measuring a property of the first fluid at one or more points along the first flowpath; moving the first movable damper from a first position, substantially obstructing the second chamber from the first flowpath, to a second position, substantially obstructing the first chamber from the first flowpath, such that a substantial portion of the first fluid is directed through the second chamber when the property fails to satisfy a threshold condition; and moving the second movable damper from a first position, substantially obstructing the second chamber from the second flowpath, to a second position, substantially obstructing the first chamber from the second flowpath, such that a substantial portion of the second fluid is directed through the second chamber when the property fails to satisfy the threshold condition.

In accordance with additional or alternative embodiments, further comprising, heating the first recovery core, the first chamber, or both.

In accordance with additional or alternative embodiments, further comprising, moving the first movable damper from the second position, substantially obstructing the first chamber from the first flowpath, to a first position, substantially obstructing the second chamber from the first flowpath, such that a substantial portion of the first fluid is directed through the first chamber when the property satisfies the threshold condition; and moving the second movable damper from a second position, substantially obstructing the first chamber from the second flowpath, to a first position, substantially obstructing the second chamber from the second flowpath, such that a substantial portion of the second fluid is directed through the first chamber when the property satisfies the threshold condition.

Further disclosed is a recovery ventilator comprising: a housing comprising a first flowpath extending from a first inlet to a first outlet and a second flowpath extending from a second inlet to a second outlet; a first recovery core comprising a plurality of first passageways and a plurality of second passageways; a second recovery core comprising a plurality of first passageways and a plurality of second passageways; a third core comprising one or more first passageways and one or more second passageways; and one or more actuators, coupled to the first recovery core, the second recovery core, and the third core and configured to shift the physical location of the first recovery core, second recovery core, and third recover cores between: a first condition wherein the plurality of first passageways of the first recovery core are disposed in fluid communication with the first fluid flowing along the first flowpath and the plurality of second passageways of the first recovery core are disposed in fluid communication with the second fluid flowing along the second flowpath, wherein the second recovery core and the third core are disposed outside of the first and second flowpaths; a second condition wherein the plurality of first passageway of the second recovery core are disposed in fluid communication with the first fluid flowing along the first flowpath and the plurality of second passageways of the second recovery core are disposed in fluid communication with the second fluid flowing along the second flowpath, wherein the first recovery core and the third core are disposed outside of the first and second flowpaths; and a third condition wherein the one or more first passageway of the third core are disposed in fluid communication with the first fluid flowing along the first flowpath and the one or more second passageways of the third core are disposed in fluid communication with the second fluid flowing along the second flowpath, wherein the first recovery core and the second recovery core are disposed outside of the first and second flowpaths.

A recovery ventilator comprising a housing comprising a first flowpath therethrough from a first inlet to a first outlet and a second flowpath therethrough from a second inlet to a second outlet, wherein the housing comprises a chamber, and wherein the first flowpath and the second flowpath cross in the chamber; a blank core comprising one or more first passageways and one or more second passageways disposed in the chamber such that the one or more first passageways are in fluid communication with the first flowpath and the one or more second passageways are in fluid communication with the second flowpath.

In accordance with additional or alternative embodiments, wherein the housing comprises two chambers and wherein a recovery core comprising a plurality of first passageways and plurality of second passageways is disposed in a first chamber such that the plurality of first passageways are in fluid communication with the first flowpath and the plurality of second passageways are in fluid communication with the second flowpath, and the blank core is disposed in the second chamber.

In accordance with additional or alternative embodiments, wherein the blank core comprises from one to ten first passageways and one to ten second passageways.

Technical effects of embodiments of the present disclosure include improved configurability of recovery ventilation devices for adaptable operation, new operability modes of recovery ventilation devices that provide for continuous operation while servicing aspects of the device, improved adaptable control of recovery ventilation devices to meet changing demand of building environmental conditions, and new multifunctional configurations allowing for combinations of heat recover, energy recovery, and/or ventilation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic illustration of an exemplary recovery ventilator having two flowpaths crossing in one chamber having a recovery core, in accordance with one or more embodiments of the disclosure.

FIG. 2 is a schematic illustration of an exemplary recovery core stack, in accordance with one or more embodiments of the disclosure.

FIG. 3 is a schematic illustration of an exemplary recovery ventilator having two flowpaths crossing in two chambers, both chambers having a recovery core, and a damper in one flowpath, in accordance with one or more embodiments of the disclosure.

FIG. 4 is a schematic illustration of an exemplary recovery ventilator having two flowpaths crossing in two chambers, both chambers having a recovery core and both flowpaths having a movable damper, in accordance with one or more embodiments of the disclosure.

FIG. 5 is a schematic illustration of an exemplary recovery ventilator having three cores and an actuator for moving the cores into and out of the flowpaths, in accordance with one or more embodiments of the disclosure.

FIG. 6 is a schematic illustration of an exemplary blank core, in accordance with one or more embodiments of the disclosure.

### DETAILED DESCRIPTION

A detailed description of one or more embodiments of the disclosed apparatus and method are presented herein by way of exemplification and not limitation with reference to the Figures.

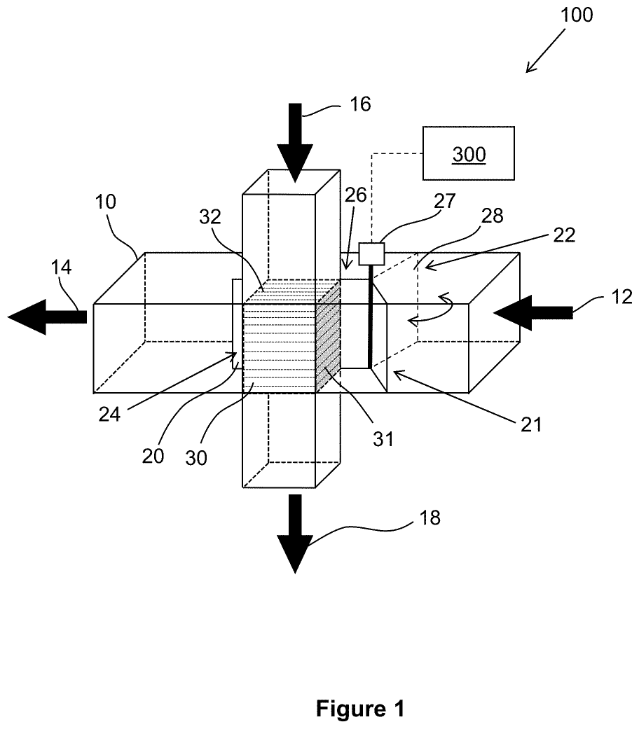

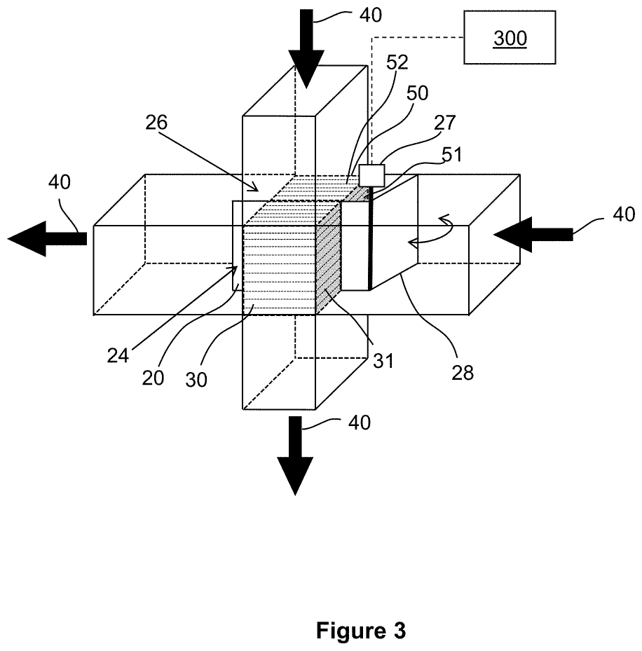

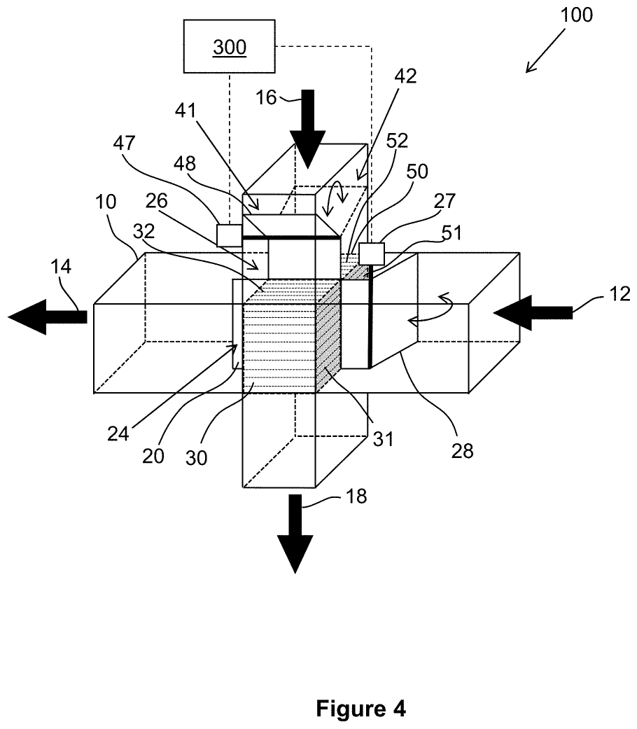

FIG. 1 is a schematic illustration of a recovery ventilator 100. The ventilator can include a housing 10 having a first flowpath therethrough, extending from a first inlet 12 to a first outlet 14, and a second flowpath therethrough, extending from a second inlet 16 to a second outlet 18. The first inlet 12 and the first outlet 14 can be disposed on opposite sides of the housing and the second inlet 16 and the second outlet 18 can be disposed on opposite sides of the housing. The recovery ventilator 100 can be configured to ventilate a space (e.g., within a building). For example, the first flowpath can include fresh outdoor air being brought into a space within the building as ventilation air and the second flowpath can include stale indoor air being exhausted from the space within the building, or vice versa (e.g., where the second flowpath represents the fresh outdoor air and the first flowpath represents stale indoor air to be exhausted). The housing 10 can include a partition 20 separating an interior volume of the housing 10 into a first chamber 24 and a second chamber 26. The ventilator 100 can be configured such that the first flowpath and the second flowpath cross in at least one of the first chamber 24 or second chamber 26. For example, the first flowpath can split at the partition 20 as it extends through both the first chamber 24 and the second chamber 26, before converging again at, or upstream of, the first outlet 14. The second flowpath can extend wholly through one of the first chamber 24, as in FIG. 1, or the second chamber 26 (not shown), or both the first chamber 24 and the second chamber 26, as in FIGS. 3-4 (e.g., split by partition 20 along both the first flowpath and the second flowpath). When the second flowpath extends wholly through one of the first chamber 24 or the second chamber 26, the first and second flowpaths cross in only the corresponding chamber. The other chamber can serve as a core bypass, allowing ventilation without recovery of moisture or thermal energy. As used herein, the flowpaths crossing can refer to two fluid streams being directed through one another along one or more flow passageways physically separating the two fluids where the flow passageways can be configured to allow, or prevent, mass transfer through one or more of the passage walls between the two fluids.

The recovery ventilator 100 can optionally include one or more fans for moving fluid through the housing 10 along the first flowpath and/or along the second flowpath. Further, the one or more fans can be disposed upstream or downstream of the first chamber 24 and second chamber 26 and can be controlled independently or in concert.

The recovery ventilator 100 can include a first movable damper 28 disposed in the first flowpath. The first movable damper 28 can be configured to apportion an amount of a first fluid flowing therein (e.g., along the first flowpath) between the first chamber 24 and the second chamber 26. For example, the first movable damper 28 can be positioned downstream of the first inlet 12 and configured to move between a first position 21 (shown in solid lines in FIG. 1) substantially obstructing the first chamber 24 from the first flowpath and a second position 22 (shown in dashed lines in FIG. 1) substantially obstructing the second chamber 26 from the first flowpath. The first movable damper 28 and the housing 10 can be configured to cooperatively substantially seal off one of the first chamber 24 or the second chamber 26 from the first flowpath. For example, in the first and/or second position, the first movable damper 28 can be configured to abut against one or more interior portions of the housing 10 (e.g., closed against one or more lips formed on one or more interior walls of the housing 10), against a frame of the first recovery core 30, or another sealing surface disposed between the first inlet 14 and the at least one of the first chamber 24 and/or the second chamber 26. The first moveable damper 28 can be positioned such that the first flowpath and the second flowpath pass through the housing 10 without crossing in either chamber (e.g., with allowance for some leakage from through the damper when in either the first position 21 or second position 22). For example, the first moveable damper can be positioned in a first position 21 such that a substantial portion of fluid flowing along the first flowpath traverses the second chamber 26 while the second flowpath extends wholly though the first chamber 24 or vice versa.

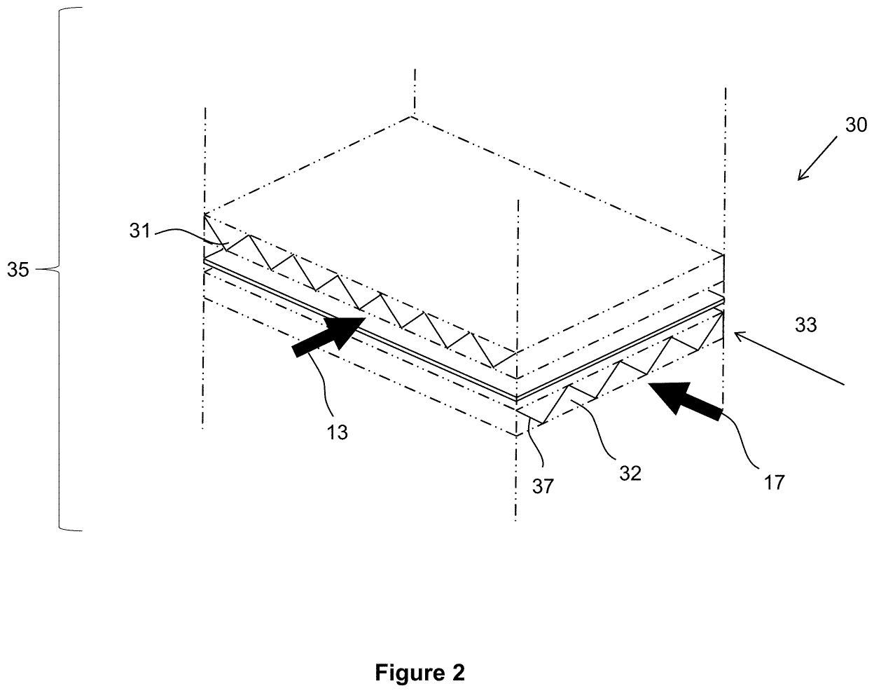

The recovery ventilator 100 can include a first recovery core 30 including a plurality of first passageways 31 in fluid communication with the first flowpath and a plurality of second passageways 32 in fluid communication with the second flowpath. The plurality of first passageways 31 can be separated from the plurality of second passageways 32 by a separator 33 as shown in FIG. 2. The separator 33 can include a membrane configured to allow for mass and/or energy transport across the membrane. For example, vapor permeable polymer membranes (e.g., including polypropylene and the like) can allow for the transfer of thermal energy and water molecules (e.g., including water molecules in liquid and/or vapor phase) across the membrane while preventing transfer of other species. When the separator 33 allows for the transfer of water and thermal energy between the adjacent flowpaths the recovery core 30 can be referred to as an energy recovery ventilator (ERV). The separator 33 can include other materials, such as aluminum which can allow for the transfer of thermal energy but no mass transfer across the separator 33. When the separator 33 allows for the transfer of thermal energy between the adjacent flowpaths without accompanying mass transfer the recovery core 30 can be referred to as a heat recovery ventilator (HRV). As disclosed herein, any of the recovery cores can be configured as either an ERV or an HRV.

A blank core is also contemplated herein. The blank core can be configured with one or more flow passages therethrough for passing the first fluid along the first flowpath and the second fluid along the second flowpath while allowing no mass transfer and minimizing thermal transfer between the adjacent fluids. The size (e.g., cross-sectional flow area, which may be viewed as the open space available for fluid to flow through along a given flow passage of the core) of the one or more flow passages of the blank core can be increased relative to an HRV or ERV core because heat and/or mass transfer between the crossing fluids is not an object of the blank core. The blank core can be configured to minimize interfacial surface area between the crossing fluids to aid in achieving adiabatic operation. Enlarging the flow passageways of the blank core, in comparison to recovery cores, can reduce the pressure drop therethrough. Further, because there is no heat or mass transfer between adjacent fluids traversing the blank core the separators 33 can include thermally insulative material (e.g., fiberglass, mineral wool, cellulose, natural fibers, polymer foam such as polystyrene foam, polyisocyanurate foam, or the like).

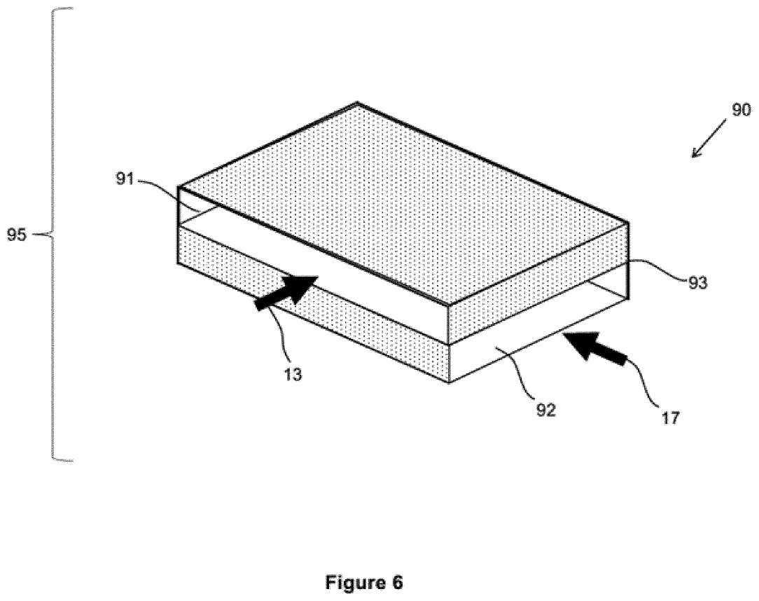

In FIG. 6, the blank core 90 can have one first passageway 91 and one second passageway 92 formed from adjacent channel (e.g., from U-shaped plates or stacked open-ended boxes). The first passageway 91 and the second passageway 92 can be disposed in perpendicular relation to one another. The blank core 90 can be disposed in a chamber of the ventilator 100 such that the one or more first passageway 91 is in fluid communication with the first flowpath 13 and the one or more second passageway 92 is in fluid with the second flowpath 17. An optional separator 93 can include thermal insulation material to prevent heat transfer between the two crossing fluids. This construction can include a single flow passage for each of the two fluids to traverse the core. In this case the dimensions of each flow passage through the blank core can be up to approximately half the size of the corresponding chamber into which the core is placed. In another construction, the blank core 90 can include a stack 95 having multiple layers of adjacent flow channels.

In manufacturing the recovery core 30, 50, it can be layered up as a stack 35, e.g., in an automated stacking process. The stack 35 can be configured for its application by selecting a desired number of layers and their arrangement. For example, higher moisture and/or heat recovery can be found when the stack 35 includes a 1:1 configuration, such that the layers of the stack 35 alternate from a layer of the plurality of first passageways 31, 51 followed by a separator 33 and a layer of the plurality of second passageways 32, 52 (e.g., excluding the end plates/layers). Conversely, lower moisture and/or heat recovery can be found when the stack 35 includes fewer adjacent layers containing different fluids. This is because of reduced surface area between the first and second fluids over which heat and mass transfer can occur, e.g., in 1:2, 2:2, 2:3, and like configurations where multiple layers of either the plurality of first passageways 31,51 or the plurality of second passageways 32, 52 are separated by one or more layers of other plurality of passageways, or vice versa. Accordingly, the ventilator 100 can be configured to cool, heat, dry, or moisten the incoming building ventilation air stream as it crosses the stale building exhaust stream through the recovery core 30, 50.

The plurality of first passageways 31 and/or the plurality of second passageways 32 can be formed by placing a spacer 37 between adjacent separators 33. In this way, the separator 33 can form the sole barrier between a first fluid and a second fluid flowing through the first recovery core 30 (e.g., flowing along the plurality of first passageways 31 can be separated from a second fluid flowing along the plurality of second passageways 31). The discrete passageways within each of the plurality of first passageways 31 and/or the plurality of second passageways 32 can intersect one another along their flowpath through the core, such as where the spacer 37 has non-continuous surfaces through the core (e.g., lanced, or otherwise includes flow openings between adjacent discrete passageways along one of the first flowpath or second flowpath).

The first recovery core 30 can be disposed in the first chamber 24 such that the plurality of first passageways 31 are in fluid communication with the first flowpath and the plurality of second passageways 32 are in fluid communication with the second flowpath. For example, the housing 10 can surround the first recovery core 30 such that the plurality of first passageways 31 can be disposed in fluid communication with a first fluid flowing from the first inlet 12 to the first outlet 14 along the first flowpath 13 and the plurality of second passageways 32 can be disposed in fluid communication with a second fluid flowing from the second inlet 16 to the second outlet 18 along the second flowpath 17. The first passageways 31 and second passageways 32 can extend non-parallel to one another. For example, the first passageways 31 and second passageways 32 can extend perpendicular to one another as depicted in FIG. 2.

The housing 10 can be made from any suitable materials. For example, the housing 10 can be formed from one or more disparate materials, such as metals (e.g., aluminum, galvanized steel, and the like), plastics (e.g., polymers such as polyethylene, polycarbonate, polypropylene, polystyrene, polyvinyl chloride, acrylonitrile butadiene styrene (ABS), and the like), composite materials (e.g., polymer resin and one or more fillers, such as for example, epoxy and fiberglass), or natural materials such as wood, or the like. The housing 10 and partition 20 can be formed together, such as in a casting or molding process, or can be formed separately and assembled, such as in a sheet metal forming and assembling process.

The recovery ventilator 100 can include a second recovery core 50 as in FIGS. 3-4. The second recovery core 50 can include a plurality of first passageways 51 and a plurality of second passageways 52. The second recovery core 50 can be disposed in the second chamber 26 such that the plurality of first passageways 51 are in fluid communication with the first flowpath 13 and the plurality of second passageways 52 are in fluid communication with the second flowpath 17. Accordingly, the recovery ventilator 100 can be configured such that the first flowpath and the second flowpath cross in both the first chamber 24 and in the second chamber 26 when they traverse the corresponding core disposed therein.

The recovery ventilator 100 can include a second movable damper 48 disposed in the second flowpath. The second movable damper 48 can be configured to apportion an amount of a second fluid flowing therein (e.g., along the second flowpath) between the first chamber 24 and the second chamber 26. For example, the second movable damper 48 can be positioned downstream of the second inlet 16 and configured to move between a first position 41 substantially obstructing the first chamber 24 from the second flowpath, and a second position 42 substantially obstructing the second chamber 26 from the second flowpath. The second movable damper 48 and the housing 10 can be configured to cooperatively substantially seal off one of the first chamber 24 or the second chamber 26 from the second flowpath. For example, in the first and/or second position, the second movable damper 48 can be configured to abut against one or more interior portions of the housing 10 (e.g., closed against one or more lips formed on one or more interior walls of the housing 10), against a frame of the second recovery core 50, or another sealing surface disposed between the second inlet 16 and the at least one of the first chamber 24 and/or the second chamber 26.

The first movable damper 28 and second movable damper 48 can each independently be configured to move to a plurality of third positions disposed between the first position and the second position such that each of the first chamber 24 and second chamber 26 are in fluid communication with the first flowpath and the second flowpath (e.g., the first and second flowpaths cross in both the first chamber 24 and the second chamber 26). The plurality of third positions can include a position where an equal amount (e.g., mass or volume) of fluid is directed through each of the first chamber 24 and the second chamber 26. The first movable damper 28 and second movable damper 48 can be controlled independently or in concert.

The first moveable damper 28 and second movable damper 48 can be positioned such that the first flowpath and the second flowpath pass through the housing 10 without crossing in either chamber (e.g., with allowance for some leakage from through the dampers when in either the first position 21,41 or second position 22,42). For example, the first moveable damper can be positioned in a first position 21 such that a substantial portion of fluid flowing along the first flowpath traverses the second chamber 26 while the second movable damper 48 can be positioned in a second position 42 such that a substantial portion of fluid flowing along the first flowpath traverses the first chamber 24, or vice versa.

The recovery ventilator 100 can include a controller 300 which may be implemented using known devices, such as a field programmable gate array (FPGA), central processing unit (CPU), microprocessor, application specific integrated circuits (ASIC), and the like. The controller 300 can be disposed in operable communication with a first actuator 27 configured to move the first movable damper 28, a second actuator 47 configured to move the second movable damper 48, the one or more fans of the ventilator 100, or a combination comprising at least one of the foregoing. The controller 300 can further be disposed in operable communication with one or more environmental sensors and can include a processor having control logic for interpreting signals from the one or more environmental sensors.

The one or more environmental sensors can be configured to measure a property of a fluid one or more points along the fluids flowpath. For example, the one or more environmental sensors can include an outdoor air temperature sensor (e.g., disposed outside a building space to be ventilated by the ventilator 100), an outdoor air humidity sensor, an outdoor air pressure sensor, an indoor air temperature sensor (e.g., disposed inside the building space to be ventilated by the ventilator 100), an indoor air humidity sensor, an indoor air pressure sensor, a first inlet temperature sensor disposed at the first inlet 12, a first inlet humidity sensor disposed at the first inlet 12, a first inlet pressure sensor disposed at the first inlet 12, a first outlet temperature sensor disposed at the first outlet 14, a first outlet humidity sensor disposed at the first outlet 14, a first outlet pressure sensor disposed at the first outlet 14, a second inlet temperature sensor disposed at the second inlet 16, a second inlet humidity sensor disposed at the second inlet 16, a second inlet pressure sensor disposed at the second inlet 16, a second outlet temperature sensor disposed at the second outlet 18, a second outlet humidity sensor disposed at the second outlet 18, a second outlet pressure sensor disposed at the second outlet 18, a first recovery core temperature, a first core first passageway pressure drop sensor comparing pressures from the inlet and outlet of the plurality of first passageways 31 of the first core recovery 30, a first core second passageway pressure drop sensor comparing pressures from the inlet and outlet of the plurality of second passageways 32 of the first core recovery 30, a second recovery core temperature, a second core first passageway pressure drop sensor comparing pressures from the inlet and outlet of the plurality of first passageways 51 of the second recovery core 50, a second core second passageway pressure drop sensor comparing pressures from the inlet and outlet of the plurality of second passageways 52 of the second core recovery 50, a third core temperature, a third core first passageway pressure drop sensor comparing pressures from the inlet and outlet of the one or more of first passageways of the third core, a third core second passageway pressure drop sensor comparing pressures from the inlet and outlet of the plurality of second passageways of the third core, or a combination comprising at least one of the foregoing.

The controller 300 can be configured in operable communication (e.g., wired, or wireless communication) with a building environmental controller, such as a thermostat of a building management system (e.g., including heating, ventilation, and/or air conditioning controls), and/or can be configured in operable communication with a user interface for configuring threshold conditions of the measured fluid properties upon which the ventilator will modify its operating state (e.g., move cores, move damper positions, and the like). The ventilator 100 can receive a target environmental conditions for the space within the building to be conditioned from the user interface and/or from the building environmental controller. For example, the user interface and/or the building environmental controller can indicate to the controller 300 that the space to be conditioned demands heating, cooling, humidification, and/or dehumidification. In response, the controller can interpret the one or more environmental sensors and modify operation of the ventilator 100 to achieve the desired goal of the building environmental controller. For example, when the space demands heating and humidification and it is cool and dry outside, then ventilator 100 can direct outdoor air into the building, and indoor air out of the building, through an ERV to recover moisture and thermal energy from the indoor air stream with the incoming indoor air stream.

The controller 300 can be configured to receive a signal from the one or more environmental sensors and to correspondingly move the first moveable damper 28, the second movable damper 48, or both. For example, the controller 300 can be configured to move the first movable damper 28 between the first position 21 where the first movable damper 28 is configured to direct a substantial portion of the first fluid flowing along the first flowpath through the second chamber 26, and a second position 22 where the first movable damper 28 is configured to direct a substantial portion of the first fluid flowing along the first flowpath through the first chamber 24, when the signal from the one or more environmental sensors satisfies a threshold condition (e.g., threshold high or low temperature, high or low humidity, high or low pressure, high or low pressure drop, or a combination thereof). Further, the controller 300 can be configured to move the second movable damper 48 between the first position 41 where the second movable damper 48 is configured to direct a substantial portion of the first fluid flowing along the first flowpath through the second chamber 26, and a second position 42 where the second movable damper 48 is configured to direct a substantial portion of the first fluid flowing along the first flowpath through the first chamber 24, when the signal from the one or more environmental sensors satisfies a threshold condition (e.g., threshold high or low temperature, high or low humidity, high or low pressure, high or low pressure drop, or a combination thereof).

For example, the controller 300 can be configured to actuate the first actuator 27 to move the first movable damper 28 from the first position 21 to the second position 22 when the first inlet temperature is below a first low inlet temperature threshold limit or above a first high inlet temperature threshold limit, when the first inlet humidity is below a first low inlet humidity threshold limit or above a first high inlet humidity threshold limit, when the first core temperature is below a first core low temperature threshold limit or above a first core high temperature threshold limit, when the first core first passageway pressure drop exceeds a first core first passageway pressure drop threshold limit, or a combination comprising at least one of the foregoing, or the like. Further, the controller 300 can be configured to actuate the second actuator 47 to move the second movable damper 48 from the first position 41 to the second position 42 when the second inlet temperature is below a second inlet temperature low threshold limit or above a second inlet temperature high threshold limit, when the second inlet humidity is below a second inlet humidity low threshold limit or above a second inlet humidity high threshold limit, when the first core temperature is below a first core low temperature threshold limit or above a first core high temperature threshold limit, when the first core first passageway pressure drop exceeds a first core first passageway pressure drop threshold limit, or a combination comprising at least one of the foregoing, or the like.

When the first inlet 12 includes fresh outdoor air and second inlet includes indoor air (e.g., to be exhausted from a building), the ventilator 100 can cool, heat, dry, or moisten the incoming air as the two air streams cross one another in one of, or both of, the first recovery core 30 and the second recovery core 50. The ventilator 100 can include one or more heaters disposed in thermal commination with the housing 10 and/or in thermal communication with one or more of the recovery cores. The one or more heaters can be configured to evaporate condensed water and/or thaw ice within the housing 10 and/or one or more of the recovery cores when conditions exist that cause such condensate and/or ice to form.

In an example of a ventilator 100 having two cores, the controller 300 can be configured to actuate both the first movable damper 28 and the second movable damper 48 in response to one or more environmental sensors. The two cores can be of the same functional type (e.g., both HRV or both ERV type cores), or can be functionally different types (e.g., one HRV core and one ERV core). When the cores are of the same functional type, the ventilator 100 can be configured to utilize only one core at a time. This can allow for maintenance of the non-utilized core without service interruption to the customer. For example, the controller 300 can be configured to move the first and second movable dampers 48 to block flow to one of the two cores along both the first and second flowpaths. In this way, when a core is plugged (e.g., from buildup of debris, condensed liquid, or ice in, or on, one of the cores), the controller 300 can sense the condition from the one or more environmental sensors and divert flow from the plugged core to the unplugged core while the plugged core is serviced. Furthermore, when the condition causing the plugging of the core is determined to be ice (e.g., by monitoring an increasing pressure drop across the core corresponding to a cold intake temperature and a high humidity exhaust, or vice versa (e.g., cold exhaust and high humidity inlet)), the controller 300 can be configured to activate the one or more heaters disposed in thermal communication with the housing 10 (e.g., particularly the chamber of the plugged core) and/or the plugged core to thaw the ice.

When the cores are not of the same functional type, for example when one core is an ERV core and the other is an HRV core, the ventilator 100 can be configured to recover heat and moisture, only heat (e.g., thermal energy), or for no recovery at all. To recover heat and moisture the ventilator 100 can be configured to direct the first flowpath and the second flowpath through the ERV core where moisture and heat can transfer between the fluids through the separator 33. To recover only heat the ventilator 100 can be configured to direct the first flowpath and the second flowpath through the HRV core where heat can transfer between the fluids through the separator 33. To prevent recovery of moisture and/or heat the ventilator 100 can be configured to direct the first flowpath through one of the HRV or ERV cores and the second flowpath through the other core, in this way the flows will not cross in either chamber and will be directed around one another (e.g., the first flowpath through the first chamber and second flowpath through the second chamber or vice versa).

The ventilator 100 can include a liquid drain in fluid communication with the first chamber 24 and/or second chamber 26 such that any liquid that condenses in either the first recovery core 30 or the second recovery core 50 and collects in the corresponding chamber can be drained from the housing 10. The ventilator 100 can include a level sensor for determining the amount of liquid that has accumulated in the housing 10 during operation. The level sensor can be configured in operable communication with the controller 300 which can be configured to open a drain valve to allow the collected liquid to drain from the housing 10 when the level sensor satisfies a high level threshold condition. The high level threshold condition for the first chamber 24 can be different than the high level threshold condition for the second chamber 26. The high level threshold condition for each chamber can correspond to the dimensions the chamber.

In another example, the ventilator 100 can include three cores. The three cores can each perform a different function. For example, one of the three cores can act as a humidity recovery core, another of the three cores can serve as an energy recovery core, and the third core can serve as a blank core that transfers little or no thermal energy between the adjacent fluid streams passing through the core (e.g., adiabatic operation). The housing 10 can be configured with one to three separate chambers for positioning a core in the first flowpath and second flowpath through the ventilator 100.

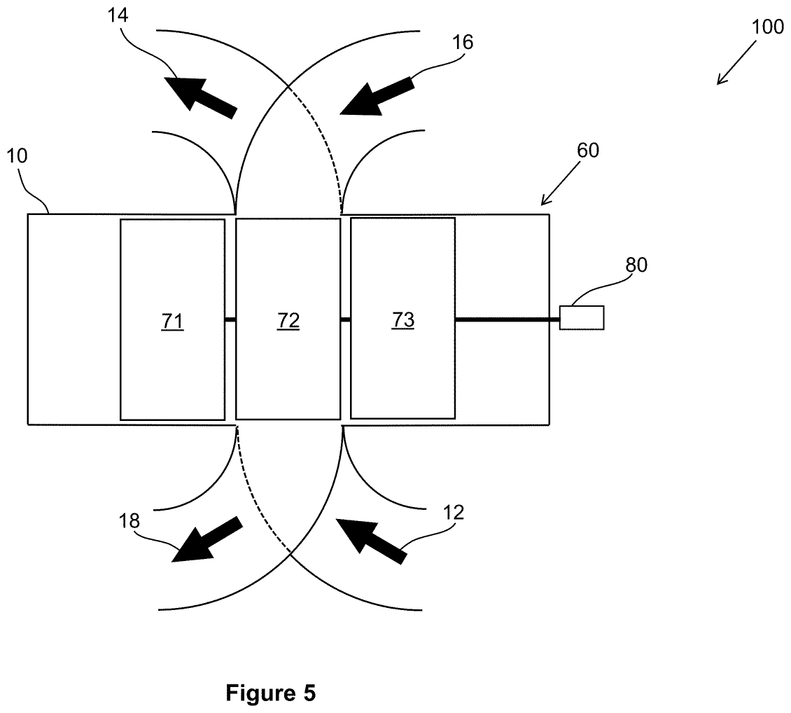

For example, with reference to FIG. 5, the housing 10 can include a single chamber 60 where the first flowpath, extending from the first inlet 12 to the first outlet 14, and the second flowpath, extending from the second inlet 16 to the second outlet 18, pass through. The single chamber 60 can be sized to hold all three cores with additional room to move the cores into and out of the flow paths. The three cores can be movably connected to a core actuator 80 for moving the cores between a first, second and third position. In the first position, a first core 71 can be positioned in fluid communication with the first and second flowpaths within the single chamber 60 while the second core 72 and third core 73 are removed from the flowpaths. In the second position, the second core 72 can be positioned in fluid communication with the first and second flowpaths within the single chamber 60 while the first core 71 and third core 73 are removed from the flowpaths. In the third position, the third core 73 can be positioned in fluid communication with the first and second flowpaths within the single chamber 60 while the first core 71 and second core 72 are removed from the flowpaths. The cores can each be configured for a different function. For example, the first core 71 can be configured to recover both thermal energy and moisture from the exhaust stream, the second core 72 can be configured to recover only thermal energy from the exhaust stream, and the third core 73 can include a blank core configured to adiabatically, and without mass transfer therebetween, pass the fluids therethrough.

The ventilator 100 can include a core actuator 80 for moving the cores between a first position, second and third position in response to the one or more environmental sensors. For example, when there is a cooling demand for a building and the outdoor air temperature is below the indoor air temperature, the controller 300 can be configured for moving the blank core into the flowpaths to allow for the cooler fresh outdoor air to enter the building without recovering heat from the exhausted building air through the blank core. Further, when there is a heating and humidity demand for the building and the outdoor air temperature and humidity are below the indoor air temperature and humidity respectively, the controller 300 can be configured for moving the energy recovery core into the flowpaths to allow for the cooler, fresh, less humid outdoor air to be heated and moisture added by the relatively hot and humid building air exhausted through the ERV core. Further the chamber 60 can include an access port for servicing one of the cores not in use without disrupting operation of the ventilator 100.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A recovery ventilator comprising:
a housing comprising a first flowpath extending from a first inlet to a first outlet and a second flowpath extending from a second inlet to a second outlet, wherein the housing comprises a partition defining a first chamber and a second chamber therein, and wherein the first flowpath extends through both the first and second chamber and the second flowpath extends through at least one of the first chamber or second chamber;
a first movable damper disposed in the first flowpath and configured to apportion an amount of a first fluid flowing therein between the first chamber and the second chamber; and
a first recovery core comprising a plurality of first passageways and a plurality of second passageways disposed in the first chamber such that the plurality of first passageways are in fluid communication with the first flowpath and the plurality of second passageways are in fluid communication with the second flowpath.

2. The recovery ventilator of claim 1, wherein the first movable damper is positioned such that the first flowpath and the second flowpath cross in at least one of the first chamber or second chamber.

3. The recovery ventilator of claim 1, further comprising a second recovery core comprising a plurality of first passageways and a plurality of second passageways, wherein the second recovery core is disposed in the second chamber such that the plurality of first passageways are in fluid communication with the first flowpath and the plurality of second passageways are in fluid communication with the second flowpath, and wherein the first flowpath the second flowpath cross in both the first chamber and second chamber.

4. The recovery ventilator of claim 1, wherein the first movable damper is configured to direct a substantial portion of the first fluid flowing therein along the first flowpath through the first chamber when in a first position and through the second chamber when in a second position.

5. The recovery ventilator of claim 1, further comprising a second movable damper disposed in the second flowpath and configured to apportion an amount of a second fluid flowing therein between the first chamber and the second chamber.

6. The recovery ventilator of claim 5, wherein the second movable damper is configured to direct a substantial portion of the second fluid flowing along the second flowpath through the first chamber when in a first position and to through the second chamber when in a second position.

7. The recovery ventilator of claim 1, wherein the plurality of first passageways and the plurality of second passageways of the first recovery core are separated by a first barrier configured to transfer at least one of water or thermal energy across the barrier.

8. The recovery ventilator of claim 2, wherein the plurality of first passageways and the plurality of second passageways of the second recovery core are separated by a second barrier configured to transfer at least one of water or thermal energy across the barrier.

9. The recovery ventilator of claim 2, wherein the first barrier of the first recovery core is configured to transfer water and thermal energy, and the second barrier of the second recovery core is configured to transfer thermal energy.

10. The recovery ventilator of claim 1, wherein the first flowpath and the second flowpath each pass through one another where they cross.

11. The recovery ventilator of claim 2, further comprising:
a third core comprising one or more first passageways and one or more second passageways; and
one or more actuators, coupled to the first recovery core, the second recovery core, and the third core and configured to shift the physical location of the first recovery core, second recovery core, and third recover cores between:
a first condition wherein the plurality of first passageways of the first recovery core are disposed in fluid communication with the first fluid flowing along the first flowpath and the plurality of second passageways of the first recovery core are disposed in fluid communication with the second fluid flowing along the second flowpath, wherein the second recovery core and the third core are disposed outside of the first and second flowpaths;
a second condition wherein the plurality of first passageway of the second recovery core are disposed in fluid communication with the first fluid flowing along the first flowpath and the plurality of second passageways of the second recovery core are disposed in fluid communication with the second fluid flowing along the second flowpath, wherein the first recovery core and the third core are disposed outside of the first and second flowpaths; and
a third condition wherein the one or more first passageway of the third core are disposed in fluid communication with the first fluid flowing along the first flowpath and the one or more second passageways of the third core are disposed in fluid communication with the second fluid flowing along the second flowpath, wherein the first recovery core and the second recovery core are disposed outside of the first and second flowpaths.

12. A space ventilating system comprising:
the ventilator as in any one of the preceding claims;
an environmental sensor comprising at least one of a first inlet temperature sensor at the first inlet, a first inlet humidity sensor at the first inlet, a first outlet temperature sensor at the first outlet, a first outlet humidity sensor at the first outlet, a second inlet temperature sensor at the second inlet, a second inlet humidity sensor at the second inlet, a second outlet temperature sensor at the second outlet or a second outlet humidity sensor at the second outlet;
a controller configured to receive a signal from the environmental sensor and to move the first movable damper between first position wherein the first movable damper is configured to direct a substantial portion of the first fluid flowing therein along the first flowpath through the first chamber, and a second position wherein the first movable damper is configured to direct a substantial portion of the first fluid flowing therein along the first flowpath through the second chamber, when the signal satisfies a threshold condition.

13. A method of ventilating a space comprising:
providing a recovery ventilator comprising a housing having a partition defining a first chamber and a second chamber therein, a first flowpath extending from a first inlet to a first outlet, a second flowpath extending from a second inlet to a second outlet, wherein the first flowpath and the second flowpath cross in at least one of the first chamber and second chamber;
a first movable damper disposed in the first flowpath and configured to apportion an amount of a first fluid flowing therein between the first chamber and the second chamber; and a first recovery core comprising a plurality of first passageways and a plurality of second passageways disposed in the first chamber such that the plurality of first passageways are in fluid communication with the first flowpath and the plurality of second passageways are in fluid communication with the second flowpath;
receiving a target environmental condition for the space;
flowing the first fluid along the first flowpath;
measuring a property of the first fluid at one or more points along the first flowpath;
and
moving the first movable damper from a first position, substantially obstructing the second chamber from the first flowpath, to a second position, substantially obstructing the first chamber from the first flowpath, such that a substantial portion of the first fluid is directed through the second chamber when the property satisfies a threshold condition.

14. The method of claim 13, further comprising, moving the first movable damper from the second position, substantially obstructing the first chamber from the first flowpath, to the first position, substantially obstructing the second chamber from the first flowpath, such that a substantial portion of the first fluid is directed through the first chamber when the property fails to satisfy the threshold condition.

15. A method of ventilating a space comprising:
providing a recovery ventilator comprising a housing having a partition defining a first chamber and a second chamber therein, a first flowpath extending from a first inlet to a first outlet, a second flowpath extending from a second inlet to a second outlet, wherein the first flowpath and the second flowpath cross in at least one of the first chamber and second chamber; a first movable damper disposed in the first flowpath and configured to apportion an amount of a first fluid flowing therein between the first chamber and the second chamber; a first recovery core comprising a plurality of first passageways and a plurality of second passageways disposed in the first chamber such that the plurality of first passageways are in fluid communication with the first flowpath and the plurality of second passageways are in fluid communication with the second flowpath; a second recovery core comprising a plurality of first passageways and a plurality of second passageways disposed in the second chamber such that the plurality of first passageways are in fluid communication with the first flowpath and the plurality of second passageways are in fluid communication with the second flowpath, and a second movable damper disposed in the second flowpath and configured to apportion an amount of a second fluid flowing therein between the first chamber and the second chamber; and
measuring a property of the first fluid at one or more points along the first flowpath;
moving the first movable damper from a first position, substantially obstructing the second chamber from the first flowpath, to a second position, substantially obstructing the first chamber from the first flowpath, such that a substantial portion of the first fluid is directed through the second chamber when the property fails to satisfy a threshold condition; and
moving the second movable damper from a first position, substantially obstructing the second chamber from the second flowpath, to a second position, substantially obstructing the first chamber from the second flowpath, such that a substantial portion of the second fluid is directed through the second chamber when the property fails to satisfy the threshold condition.

16. The method of claim 15, further comprising, moving the first movable damper from the second position, substantially obstructing the first chamber from the first flowpath, to a first position, substantially obstructing the second chamber from the first flowpath, such that a substantial portion of the first fluid is directed through the first chamber when the property satisfies the threshold condition; and
moving the second movable damper from a second position, substantially obstructing the first chamber from the second flowpath, to a first position, substantially obstructing the second chamber from the second flowpath, such that a substantial portion of the second fluid is directed through the first chamber when the property satisfies the threshold condition.

17. A recovery ventilator comprising:
a housing comprising a first flowpath extending from a first inlet to a first outlet and a second flowpath extending from a second inlet to a second outlet;
a first recovery core comprising a plurality of first passageways and a plurality of second passageways;
a second recovery core comprising a plurality of first passageways and a plurality of second passageways;
a third core comprising one or more first passageways and one or more second passageways; and
one or more actuators, coupled to the first recovery core, the second recovery core, and the third core and configured to shift the physical location of the first recovery core, second recovery core, and third recover cores between:
a first condition wherein the plurality of first passageways of the first recovery core are disposed in fluid communication with the first fluid flowing along the first flowpath and the plurality of second passageways of the first recovery core are disposed in fluid communication with the second fluid flowing along the second flowpath, wherein the second recovery core and the third core are disposed outside of the first and second flowpaths;
a second condition wherein the plurality of first passageway of the second recovery core are disposed in fluid communication with the first fluid flowing along the first flowpath and the plurality of second passageways of the second recovery core are disposed in fluid communication with the second fluid flowing along the second flowpath, wherein the first recovery core and the third core are disposed outside of the first and second flowpaths; and
a third condition wherein the one or more first passageway of the third core are disposed in fluid communication with the first fluid flowing along the first flowpath and the one or more second passageways of the third core are disposed in fluid communication with the second fluid flowing along the second flowpath, wherein the first recovery core and the second recovery core are disposed outside of the first and second flowpaths.

18. A recovery ventilator comprising:
a housing comprising a first flowpath therethrough from a first inlet to a first outlet and a second flowpath therethrough from a second inlet to a second outlet, wherein the housing comprises a chamber, and wherein the first flowpath and the second flowpath cross in the chamber;
a blank core comprising one or more first passageways and one or more second passageways disposed in the chamber such that the one or more first passageways are in fluid communication with the first flowpath and the one or more second passageways are in fluid communication with the second flowpath.

19. The recovery ventilator of claim 18, wherein the housing comprises two chambers and wherein a recovery core comprising a plurality of first passageways and plurality of second passageways is disposed in a first chamber such that the plurality of first passageways are in fluid communication with the first flowpath and the plurality of second passageways are in fluid communication with the second flowpath, and the blank core is disposed in the second chamber.

20. The recovery ventilator of claim 18, wherein the blank core comprises from one to ten first passageways and one to ten second passageways.
